(19) United States
(12) Patent Application Publication
(10) Pub. No.: US 2019/0116036 A1
(43) Pub. Date: Apr. 18, 2019

(54) SYSTEM AND METHOD FOR BUILDING A BLOCKCHAIN APPLICATION

(71) Applicant: HCL TECHNOLOGIES LIMITED, Uttar Pradesh (IN)

(72) Inventors: RAHUL SABHARWAL, UTTAR PRADESH (IN); ROHIT THUKRAL, UTTAR PRADESH (IN); VINEET GOGIA, HARYANA (IN)

(21) Appl. No.: 16/163,335

(22) Filed: Oct. 17, 2018

(30) Foreign Application Priority Data
Oct. 17, 2017 (IN) 201711036918

(51) Int. Cl. H04L 9/32; G06F 17/30

(52) U.S. Cl. CPC H04L 9/32; G06Q 2220/00; G06F 17/30283

(57) ABSTRACT

The present disclosure relates to system(s) and method(s) for building a blockchain application. The system configured to maintain a set of domains and a set of application service blocks. Further, the system receives domain data from a user. The domain data comprises information associated with a target domain, and a set of domain services. Once the domain data is received, the system identifies a subset of application service blocks, from the set of application service blocks. The system further builds one or more adapters for each application service block, from the subset of application service blocks, based on correlation between the subset of application service blocks. Upon building the one or more adapters, the system links the subset of application service blocks using the one or more adapters. Further, the blockchain application, compatible with the target domain, may be generated based on linking the subset of application service blocks.

### CROSS-REFERENCE TO RELATED APPLICATIONS AND PRIORITY

The present application claims benefit from Indian Complete Patent Application 201711036918 filed on 17 Oct. 2017 the entirely of which is hereby incorporated by reference.

### TECHNICAL FIELD

The present disclosure in general relates to the field of a blockchain technology. More particularly, the present invention relates to a system and method for building a blockchain application.

### BACKGROUND

Currently, a blockchain platform such as Hyperledger, Ethereum, etc., are available in market. The blockchain platforms are used to build a blockchain application for a business application such as Healthcare, Media and the like. The blockchain platform that are available in the market provide capability for distributed and decentralized ledger, ability to write smart contract etc. However, the blockchain applications are used for developing static applications. Thus, the blockchain application built for one business application cannot be used for other business application. Also an application code developed as a smart contract or chain code in the blockchain application is not re-usable. Thus, a user has to build the entire blockchain application for different business applications. However, building the entire blockchain application every time is a time consuming process.

Further, the blockchain platform provides a horizontal and business-agnostic mechanism to write the blockchain application on top of the blockchain platform. In this case, writing the blockchain application on top of the blockchain platform is feasible, when the blockchain applications related to the business application is single. But, it becomes problematic when the user wants to write multiple blockchain applications for the business application on top of the blockchain platform.

### SUMMARY

Before the present systems and methods for building a blockchain application, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and method for building the blockchain application. This summary is not intended to identify essential features of the claimed subject matter nor is it intended for use in determining or limiting the scope of the claimed subject matter.

In one implementation, a system for building a blockchain application is illustrated. The system comprises a memory and a processor coupled to the memory, further the processor is configured to execute programmed instructions stored in the memory. In one embodiment, the processor may execute programmed instructions stored in the memory for maintaining a set of domains and a set of application service blocks. The set of application service blocks is used to build a domain specific service. The processor may further execute programmed instructions stored in the memory for receiving domain data from a user. In one embodiment, the domain data may comprise information associated with a target domain and a set of domain services, associated with the target domain. Further, the processor may execute the programmed instructions stored in the memory for identifying a subset of application service blocks, from the set of application service blocks, based on analysis of the target domain and the set of domain services. Furthermore, the processor may execute the programmed instructions stored in the memory for building one or more adapters for each application service block, from the subset of application service blocks. The one or more adapters may be build based on correlation between the subset of application service blocks. Further, the processor may execute the programmed instructions stored in the memory for linking the subset of application service blocks using the one or more adapters. Upon linking the subset of application service blocks, the processor may execute the programmed instructions stored in the memory for generating the blockchain application compatible with the target domain.

In another implementation, a method for building a blockchain application is illustrated. In one embodiment, the method may comprise maintaining a set of domains and a set of application service blocks. The set of application service blocks may be used to build a domain specific service. Further, the method may comprise receiving domain data from a user. In one embodiment, the domain data may comprise information associated with a target domain and a set of domain services, associated with the target domain. Furthermore, the method may further comprise identifying a subset of application service blocks, from the set of application service blocks, based on analysis of the target domain and the set of domain services. Further, the method may comprise building one or more adapters for each application service block, from the subset of application service blocks, based on correlation between the subset of application service blocks. Furthermore, the method may comprise linking the subset of application service blocks using the one or more adapters. Upon linking the subset of application service blocks, the method may comprise generating the blockchain application compatible with the target domain.

In yet another implementation, a computer program product having embodied computer program for building a blockchain application is disclosed. In one embodiment, the program may comprise a program code for maintaining a set of domains and a set of application service blocks. The set of application service blocks may be used to build a domain specific service. Further, the program may comprise a program code for receiving domain data from a user. In one embodiment, the domain data may comprise information associated with a target domain and a set of domain services, associated with the target domain. Furthermore, the program may comprise a program code for identifying a subset of application service blocks, from the set of application service blocks, based on analysis of the target domain and the set of domain services. Further, the program may comprise a program code for building one or more adapters for each application service block, from the subset of application service blocks, based on correlation between the subset of application service blocks. Furthermore, the program may comprise a program code for linking the subset of application service blocks using the one or more adapters. Upon linking the subset of application service blocks, the program may comprise a program code for generating the blockchain application compatible with the target domain.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for building a blockchain application, in accordance with an embodiment of the present subject matter.

FIG. 2 illustrates the system for building the blockchain application, in accordance with an embodiment of the present subject matter.

FIG. 3 illustrates a method for building a blockchain application, in accordance with an embodiment of the present subject matter.

FIG. 4 illustrates an example of multiple blockchain applications built on top of a blockchain platform, in accordance with an embodiment of the present subject matter.

FIG. 5 illustrates an example of linking between the subset of application service blocks to deliver a call from a blockchain business application, in accordance with an embodiment of the present subject matter.

### DETAILED DESCRIPTION

Some embodiments of the present disclosure, illustrating all its features, will now be discussed in detail. The words “maintaining”, “receiving”, “identifying”, “building”, “linking”, and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an” and “the” include plural references unless the context clearly dictates otherwise. Although any systems and methods similar or equivalent to those described herein can be used in the practice or testing of embodiments of the present disclosure, the exemplary, systems and methods for building a blockchain application are now described. The disclosed embodiments of the system and method for building the blockchain application are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure for building a blockchain application is not intended to be limited to the embodiments illustrated, but is to be accorded the widest scope consistent with the principles and features described herein.

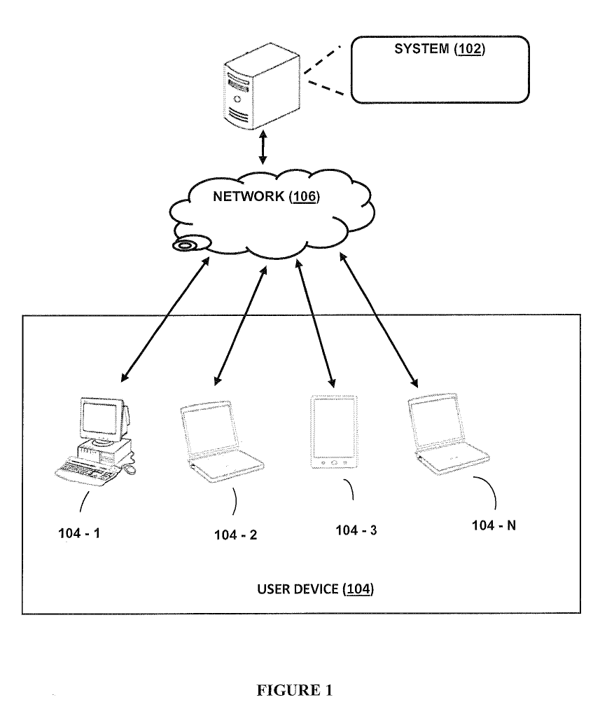

The present subject matter relates to building a blockchain application. In one embodiment, the blockchain application may be built over a blockchain platform. The blockchain platform may be a Hyperledger, a Ethereum, and the like. The blockchain platform provides ability related to distributed and decentralized ledger, cryptography based security, write smart contracts and the like. In one aspect, a set of domains and a set of application service blocks may be maintained in a repository. In one embodiment, domain data may be received from a user. The domain data may comprise a target domain and a set of domain services, associated with the target domain. Once the domain data is received, a subset of application service blocks, from the set of application service blocks, may be identified. The subset of application service blocks may be identified based on the target domain and the set of domain services. Upon identifying the subset of application service blocks, one or more adapters may be build. The one or more adapters may be build based on correlation between the subset of application service blocks. In one embodiment, the one or more adapters may be built for each application service block from the subset of application service blocks. Once the one or more adapters are build, the subset of application service blocks may be linked using the one or more adapters. Based on linking the subset of application service blocks, the blockchain application may be generated. In one aspect, the blockchain application may be compatible with the target domain. Further, the network implementation of system for building the blockchain application is illustrated with FIG. 1.

Referring now to FIG. 1, a network implementation 100 of a system 102 for building a blockchain application is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented over a cloud network. Further, it will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a network 106.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

In one embodiment, the system 102 may be configured to maintain a set of domains and a set of application service blocks in a repository. The set of application service blocks is associated with one or more services associated with the set of domains. In one aspect, the set of application service blocks may be used to build a domain specific services. In one example, the set of application service blocks may comprise an identity service, an access service, a configuration service, a template service, an entity service, an entity collection service, a search service, a notification service, a compensation service, a transaction service, a compliance service, an operation and management service, a dashboard, an analytics, a traceability, a just-in-time demand forecasting and payments, and the like. In one example, the set of domains may comprise a supply chain application, a financial service domain, a media, a healthcare service domain, an airline service domain and the like.

Further, the system 102 may be configured to receive domain data. In one example, the domain data may be received from a user. The domain data may comprise information corresponding to a target domain, a set of domain services associated with the target domain, and the like. Once the domain data is received, the system 102 may be configured to analyze the target domain and the set of domain services. In one example, the system 102 may check whether the application service blocks, stored in the repository, are sufficient to build the domain specific services.

Upon analyzing the target domain and the set of domain services, the system 102 may identify a subset of application service blocks, from the set of application service blocks. In one example, the subset of application service blocks may be associated with the domain specific services. Once the subset of application service blocks is identified, the system 102 may be configured to build one or more adapters for each application service block, from the subset of application service blocks. In one aspect, the one or more adapters may be build based on correlation between the subset of application service blocks.

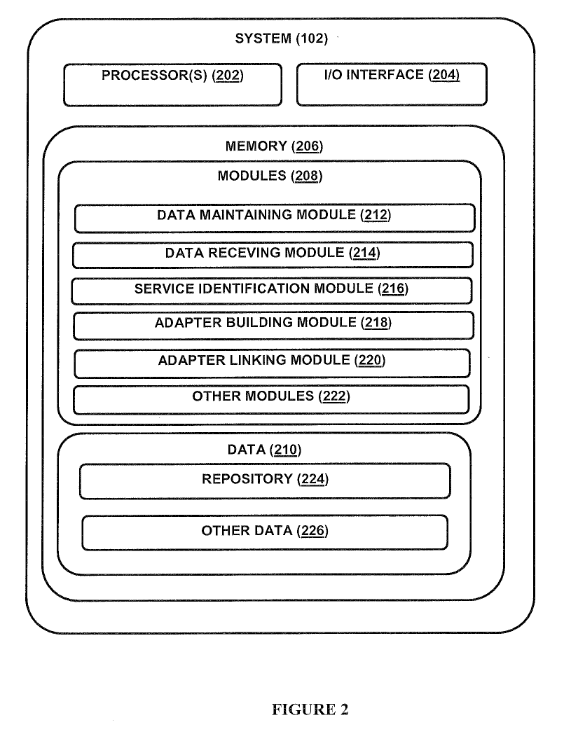

Once the one or more adapters are build, the system 102 may be configured to link the subset of application service blocks using the one or more adapters. Upon linking the subset of application service blocks, the system 102 may be configured to generate the blockchain application. The blockchain application may be compatible with the target domain. Further, the system for building the blockchain application is elaborated with respect to FIG. 2.

Referring now to FIG. 2, the system 102 for building a blockchain application is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include data maintaining module 212, data receiving module 214, a service identification module 216, an adapter building module 218, an adapter linking module 220, and other modules 222. The other modules 222 may include programs or coded instructions that supplement applications and functions of the system 102.

The data 210, amongst other things, serve as a repository for storing data processed, received, and generated by one or more of the modules 208. The data 210 may also include a repository 224, and other data 226. In one embodiment, the other data 226 may include data generated as a result of the execution of one or more modules in the other modules 222.

In one implementation, a user may access the system 102 via the I/O interface 204. The user may be registered using the I/O interface 204 in order to use the system 102. In one aspect, the user may access the I/O interface 204 of the system 102 for obtaining information, providing input information or configuring the system 102.

In one embodiment, the data maintaining module 212 may be configured to maintain a set of domains and a set of application service blocks. The set of domains and the set of application service blocks may be maintained in the repository 224. In one aspect, the set of application service blocks may be associated with one or more services, provided by the set of domains. In another aspect, the set of application block services may be used to build a domain specific services. In one example, each application service blocks, from the set of application service blocks, may be used in building different services, associated with the set of domains.

In one aspect, the set of domains may comprise domains such as a supply chain application, a financial service domain, a media domain, a healthcare service domain, an airline service domain and the like. In one embodiment, it may be understood that the set of domain may comprise all the domains for which the blockchain application is build.

In one aspect, the set of application service blocks may comprise an identity service, an access service, a configuration service, a template service, an entity service, an entity collection service, a search service, a notification service, a compensation service, a transaction service, a compliance service, an operation and management service and the like. In another aspect, the set of application service blocks may also comprise one or more enhanced services such as a dashboard, an analytics, a traceability, a just-in-time demand forecasting and payments, and the like. In one embodiment, it may be understood that the set of application service blocks comprises generic services that may be used to build the domain specific services.

In one embodiment, the configuration service may be one of a core service associated with the blockchain application. The configuration service may be configured to configure and communicate with multiple blockchain platforms, different repositories, different authentication sources, different authorization mechanisms and the like.

Further, the identity service may be configured to manage user's authentication to access the blockchain application. The identity service may accessible, to an authenticated user, from one or more sources. The one or more sources may correspond to the repository, a blockchain certificate, an active directory and the like.

Furthermore, the access service may be configured to manage authorization of the user to perform any action in the blockchain application. The access service may be accessible, to an authorize user, from one or more sources. The one or more sources may correspond to the repository, the blockchain certificate and the like.

Furthermore, the entity service and the entity collection service may be configured to manage entities such as Create, Update, and Delete (CRUD) over the blockchain application. Further, the entity model and the entity collection service, along with the template model, may be configured to manage domain data received from the user.

Furthermore, the template service may be configured to provide capability to generate a template. The template may be configured to allow the entity service and the entity collection service to work on information associated with the set of domains and the domain specific services.

Furthermore, the search service may be configured to search the entity and the entity collections from the blockchain application. In one example, the search service may be used to search the application service blocks, used to build the domain specific services.

Furthermore, the notification service may be configured to send a notification/alert to the user. The notification/alert may be associated with one or more system transactions. Further, the notification service may provide the notification/alert regarding updates, associated with the transactions.

Furthermore, the operation and management service may be configured to monitor one or more services for a blockchain network, a network health, a transaction volume monitoring, re-submitting failed transactions and the like.

Furthermore, the cache service may be configured to cache information associated with the blockchain application. The information may correspond to the one or more adapters, an authentication token, and the like.

Furthermore, the compliance service may be configured to flag one or more transactions, performed by the blockchain application, that are not meeting a compliance parameter for the blockchain network. The compliance service may be referred as an auditing service. Further, the compliance service may deliver an auditing information associated with the blockchain network.

Furthermore, the document management service may be configured to store and manage documents, associated with the blockchain application, in the repository.

Further, the data receiving module 214 may be configured to receive domain data. In one aspect, the domain data may be received from the user. In another aspect, the domain data may be gathered from the repository 224, when the target domain is received from the user. In one embodiment, the domain data may comprise information associated with a target domain and a set of domain services, associated with the target domain. In one example, the set of domain services may be domain services that are provided by the target domain. It may be understood that the set of domain services may vary for different domains, from the set of domains.

In one embodiment, considering the target domain as the financial service domain. In this case, the set of domain services, associated with the financial service, may comprise Know Your Customer (KYC), a trade finance, a smart contract driven bonds and Escrow.

Once the domain data is received, the service identification module 216 may be configured to identify a subset of application service blocks, from the set of application service blocks. The subset of application service blocks may be associated with the set of services. The subset of application service blocks may be identified based on an analysis of the target domain and the set of domain services. In one example, each application service block, from the subset of application service blocks, may be used multiple times to build the set of services.

In one embodiment, the service identification module 216 may first check if an application service block, associated with the set of services, is available in the repository 224. If the application service block, associated with the set of services, is available, the service identification module 216 may select the application service blocks, from the set of application service blocks, to build the set of services.

In another embodiment, if the application service block, associated with the set of services, is not available in the repository, the service identification module 216 may enable the user to create the application service block. In this case, the user may write a code to create the application service block, associated with the set of services.

Upon identifying the subset of application service blocks, the adapter building module 218 may be configured identify a correlation between the subset of application service blocks. The correlation may correspond to connection between functionality of each application service block, from the subset of application service blocks. Once the correlation between the subset of application service blocks is identified, the adapter building module 218 may be configured to build one or more adapters for each application service block, from the subset of application service blocks. In one example, the adapter building module 218 may receive a program code, associated with the one or more adapters, from the user. Once the program code is received, the building module 218 may build the one or more adapters based on executing the program code. In one aspect, the user may be able to configure the one or more adapters, based on the subset of application service blocks.

In one embodiment, the building module 218 may be configured to configure functionality of the subset of application service blocks upon building the one or more adapters. The one or more adapters may enable each application service block, from the subset of application service blocks, to provide different implementation of functionality of the application service block. Thus, the one or more adapters may configure the subset of application service blocks. In other words, the subset of application service blocks performs function based on the one or more adapters.

In one exemplary embodiment, considering the subset of application service blocks may comprise the identity service, and the access service. In this case, the adapter building module 218 may identify the correlation between the identity service and the access service. In this case, the correlation may indicate that once an authentication token, received from the user, is identified by the identity service, the access service may provide an authorization to the user.

Once the one or more adapters are built, the adapter linking module 220 may be configured to link the subset of application service blocks using the one or more adapters. Upon linking the subset of application service blocks, the adapter linking module 220 may generate the blockchain application. In one example, the blockchain application may be a chain of the application service blocks, from the subset of application service blocks. The blockchain application may be compatible with the target domain, as the subset of application service blocks is identified based on the information associated with the target domain.

In one embodiment, the blockchain application may be built on top of the blockchain platform such as Hyperledger, Ethereum and the like. The blockchain application may be configured to interact with multiple blockchain platforms. In one example, the blockchain application built on top of the Hyperledger platform may work properly on top of the Ethereum platform. Thus, the blockchain application may be a re-used over multiple blockchain platforms.

Exemplary embodiments discussed above may provide certain advantages. Though not required to practice aspects of the disclosure, these advantages may include those provided by the following features.

Some embodiments of the system and the method enables re-usability of the blockchain application for different domains.

Some embodiments of the system and the method enables interaction of the blockchain application with different blockchain platforms.

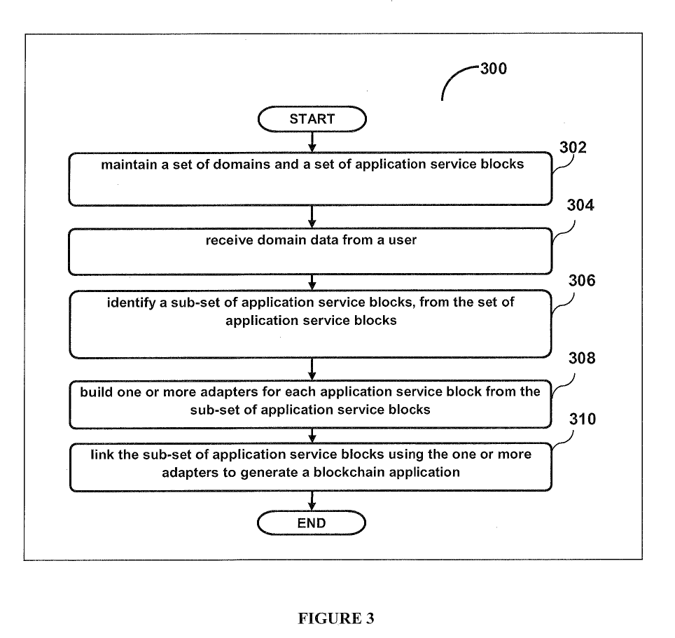

Referring now to FIG. 3, a method 300 for building a blockchain application, is disclosed in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, a set of domains and a set of application service blocks may be maintained in a repository. In one implementation, the data maintaining module 212 may maintain the set of domains and the set of application service blocks. In one aspect, the set of application service blocks may be associated with one or more services, provided by the set of domains. In another aspect, the set of application block services may be used to build a domain specific services.

At block 304, domain data may be received from a user. In one implementation, the data receiving module 214 may receive the domain data. The domain data may comprise information associated with a target domain and a set of domain services, associated with the target domain. In one example, the set of domain services may be domain services that are provided by the target domain.

At block 306, a subset of application service blocks, from the set of application service blocks, may be identified. In one implementation, the service identification module 216 may identify the subset of application service blocks, from the set of application service blocks. The subset of application service blocks may be associated with the set of services. The subset of application service blocks may be identified based on an analysis of the target domain and the set of domain services.

At block 308, one or more adapters, for each application service block, from the subset of application service blocks, may be built. In one implementation, the adapter building module 218 may build one or more adapters. In one example, the one or more adapters may be built based on correlation between the subset of application service blocks.

At block 310, the one or more adapters may be used to link the subset of application service blocks. In one implementation, the adapter linking module 220 may link the subset of application service blocks using the one or more adapters. Upon linking the subset of application service blocks, the blockchain application may be generated. The blockchain application may be compatible with the target domain, as the subset of application service blocks is identified based on the information associated with the target domain.

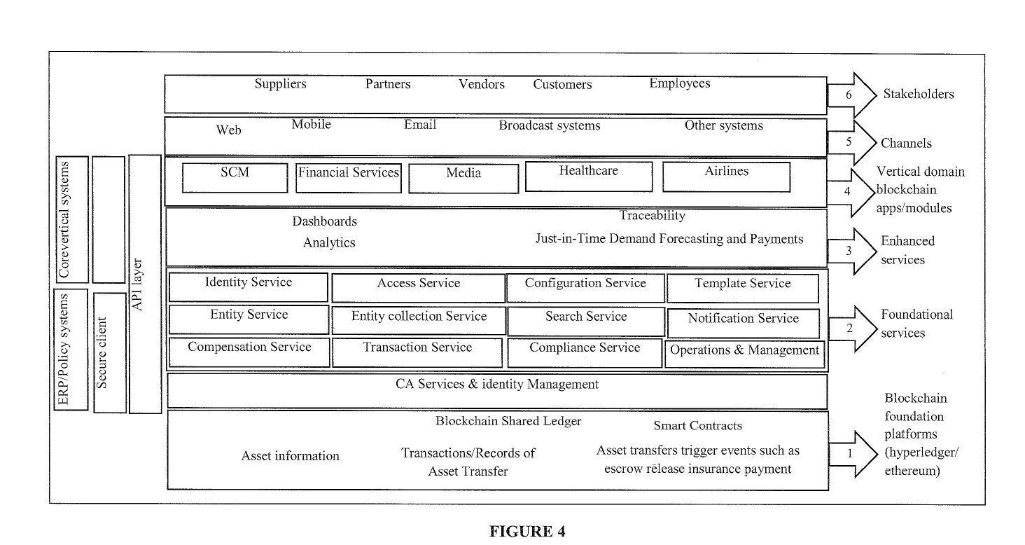

Referring now to FIG. 4, an example of multiple blockchain applications built on top of a blockchain platform, is disclosed in accordance with an embodiment of the present subject matter. In one embodiment, the blockchain application development may comprise six different layers such as layer 1 (blockchain platform), layer 2 (foundation services), layer 3 (enhanced services), layer 4 (vertical domain blockchain applications), layer 5 (channels), and layer 6 (stakeholders).

In one embodiment, the layer 1 may correspond to a layer of the blockchain platforms such as Hyperledger, Ethereum, and the like. The layer 1 further represents a storage of asset information, transaction/records of asset transfer and smart contract. The layer 1 provides ability related to distributed and decentralized ledger, consensus mechanism, writing smart contracts, cryptography based security and the like. In other words, the layer 1 is a base layer on the top of which the blockchain application is built.

Further, the layer 2 and the layer 3 together comprises a set of application service blocks. The application service blocks from the layer 2 may be referred as a foundational service. The application service blocks from the layer 3 may be referred as an enhanced service. In one example, the layer 2 and the layer 3 together may be referred as an blockchain application platform. In one embodiment, the set of application service blocks may comprise an identity service, an access service, a configuration service, a template service, an entity service, an entity collection service, a search service, a notification service, a compensation service, a transaction service, a compliance service, an operation and management service, a dashboard, an analytics, a traceability, and a just-in-time demand forecasting and payment. In one example, the set of application block services may be generic services that may be used to build the blockchain application for different domains.

Furthermore, the layer 4 may represent a set of domain. The set of domains may comprise domains such as a Supply Chain Management (SCM), a financial service, a media, a healthcare, an airline. The layer 4 may also represent the blockchain applications associated with each domain from the set of domains. In one embodiment, the blockchain application, associated with the SCM, may be a traceability, a provenance, a regulatory compliance, a smart contract (procurement). Further, the blockchain application, associated with the financial service, may be Know Your Customer (KYC), a trade finance, a smart contract driven bonds, an escrow. Furthermore, the blockchain application, associated with the media, may be a compliance on content usage, a smart contract for compensation, a payment based on IP. Furthermore, the blockchain application, associated with the healthcare, may be an electronic medical records, a smart contract driven insurance. Furthermore, the blockchain application, associated with the airlines, may be MRO (Maintenance, Repair and Overhaul operations), and tickets management.

Furthermore, the layer 5 may represent a set of channels that is used to access the blockchain application. The set of channels may comprise a web, a mobile, an e-mail, a broadcast system, and other systems. In one aspect, the user may access the blockchain application through a digital channel or an API layer.

Furthermore, the layer 6 may represent stakeholders accessing the blockchain application. The stakeholders may correspond to a supplier, a partner, a vendor, a customer, and an employee. In one aspect, the stakeholders may use the set of channels to access the blockchain application.

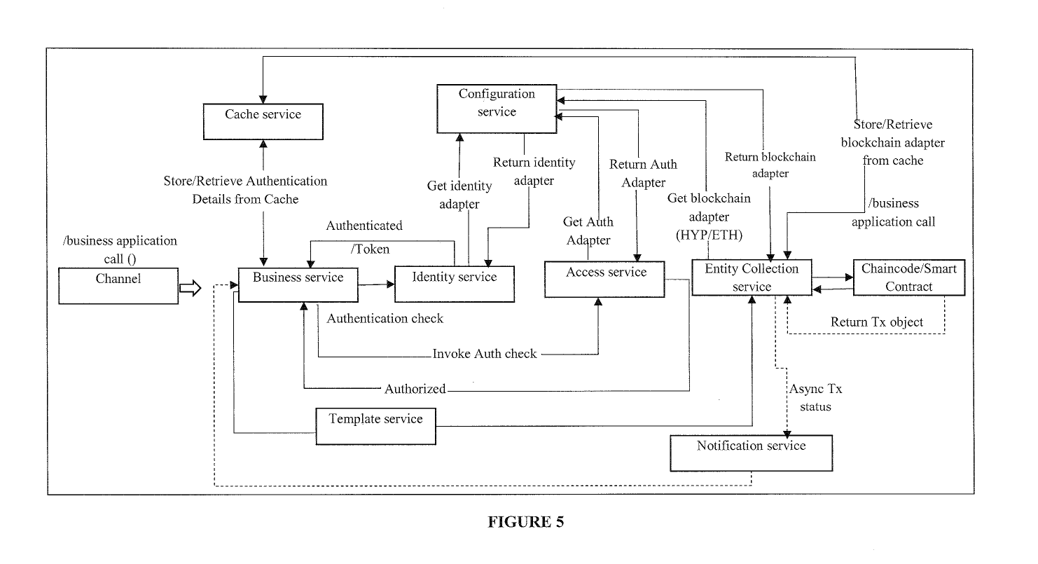

Referring now to FIG. 5, an example of linking between the subset of application service blocks to deliver a call from a blockchain business application, is disclosed in accordance with present subject matter. In one embodiment, the subset of application service blocks comprises the cache service, the configuration service, the business service, the identity service, the access service, the entity collection service, the template service, the notification service, and the chain codes/smart contracts. The subset of application service blocks may be linked with the one or more adapters.

In one aspect, the business service may be linked to the cache service using the adapter corresponding to store/retrieve authentication details from cache. Further, the business service may be connected to the identity service using an authenticated/token adapter, and authentication check adapter. Similarly, other application service blocks may be connected to other application service blocks using different adapters. It may be understood from the FIG. 5 that the one or more adapters, linking the application service blocks, may enable the application service block to perform a particular function.

In one embodiment, the business service may retrieve authentication details, associated with a user, from the cache service. Further, the identity service may perform authentication check for the authentication details, received by the business service. Once the authentication details are authenticated by the identity service, the access service may be configured to provide an authorization to the user. Upon providing the authorization to the user, the template service and the entity collection service may be configured to build and configure the blockchain application, over a blockchain platform. Once the blockchain application is built, the chain codes/smart contracts may enable writing smart contracts. In this case, the configuration service may be configured to enable configuration of the blockchain application regarding a target domain.

Although implementations for systems and methods for building a blockchain application have been described, it is to be understood that the appended claims are not necessarily limited to the specific features or methods described. Rather, the specific features and methods are disclosed as examples of implementations for building the blockchain application.

We claim:

1. A system for building a blockchain application, the system comprising:
a memory;
a processor coupled to the memory, wherein the processor is configured to execute programmed instructions stored in the memory to:
maintain a set of domains and a set of application service blocks, wherein the set of application service blocks is used to build a domain specific service;
receive domain data from a user, wherein the domain data comprises information associated with a target domain, and a set of domain services associated with the target domain;
identify a subset of application service blocks, from the set of application service blocks, based on analysis of the target domain, and the set of domain services;
build one or more adapters for each application service block from the subset of application service blocks based on correlation between the subset of application service blocks; and
link the subset of application service blocks using the one or more adapters to generate a blockchain application compatible with the target domain.

2. The system of claim 1, wherein the one or more adapters are configured to configure each application service block from the subset of application service to provide different function.

3. The system of claim 1, wherein the blockchain application is configured to interact with multiple blockchain platform, and wherein the blockchain platform corresponds to one of: Hyperledger, or Ethereum.

4. A method for building a blockchain application, the method comprises steps of:
maintaining, by a processor, a set of domains and a set of application service blocks, wherein the set of application service blocks is used to build a domain specific service;
receiving, by the processor, domain data from a user, wherein the domain data comprises information associated with a target domain, and a set of domain services associated with the target domain;
identifying, by the processor, a subset of application service blocks, from the set of application service blocks, based on analysis of the target domain, and the set of domain services;
building, by the processor, one or more adapters for each application service block from the subset of application service blocks based on correlation between the subset of application service blocks; and
linking, by the processor, the subset of application service blocks using the one or more adapters to generate a blockchain application compatible with the target domain.

5. The method of claim 4, wherein the one or more adapters are configured to configure each application service block from the subset of application service to provide different function.

6. The method of claim 4, wherein the blockchain application is configured to interact with multiple blockchain platform, and wherein the blockchain platform corresponds to one of: Hyperledger, or Ethereum.

7. A computer program product having embodied thereon a computer program for building a blockchain application, the computer program product comprises:
a program code for maintaining a set of domains and a set of application service blocks, wherein the set of application service blocks is used to build a domain specific service;
a program code for receiving domain data from a user, wherein the domain data comprises information associated with a target domain, and a set of domain services associated with the target domain;
a program code for identifying a subset of application service blocks, from the set of application service blocks, based on analysis of the target domain, and the set of domain services;
a program code for building one or more adapters for each application service block from the subset of application service blocks based on correlation between the subset of application service blocks; and
a program code for linking the subset of application service blocks using the one or more adapters to generate a blockchain application compatible with the target domain.
